(19) United States
(12) Patent Application Publication
(10) Pub. No.: US 2010/0001620 A1
(43) Pub. Date: Jan. 7, 2010

(54) MICROSTRUCTURE OF PEROVSKITE-TYPE OXIDE SINGLE CRYSTAL AND METHOD OF MANUFACTURING THE SAME, COMPOSITE PIEZOELECTRIC MATERIAL, PIEZOELECTRIC VIBRATOR, ULTRASONIC PROBE, AND ULTRASONIC DIAGNOSTIC APPARATUS

(75) Inventors: Shigenorii YUUYA, Kaisei-machi (JP); Masayuki Suzuki, Kaisei-machi (JP); Masahiro Takata, Kaisei-machi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/486,518

(22) Filed: Jun. 17, 2009

(30) Foreign Application Priority Data
Jul. 4, 2008 (JP) 2008-175746

(51) Int. Cl. G10K 9/125; B32B 19/00

(52) U.S. Cl. 310/336; 252/62.9 R; 252/62.9 PZ; 117/8

(57) ABSTRACT

A method of manufacturing a microstructure of perovskite-type oxide single crystal having a desired composition and exhibiting excellent properties. The method includes the steps of: (a) forming a coating layer on a surface of a seed single crystal substrate, the coating layer containing the same metallic elements as those in a predetermined perovskite-type oxide; (b) forming a joint body having a micro-structured precursor of the predetermined perovskite-type oxide adhered to a surface of the coating layer; and (c) heat-treating the joint body to induce solid phase epitaxy, and thereby, single-crystallizing the precursor.

### CROSS-REFERENCE TO RELATED APPLICATION

The present application claims priority from Japanese Patent Application No. 2008-175746 filed on Jul. 4, 2008, the contents of which are incorporated herein by reference in their entirety.

### BACKGROUND OF THE INVENTION

1. Field of the Invention

The present invention relates to a microstructure of perovskite-type oxide single crystal and a method of manufacturing the same. Furthermore, the present invention relates to a composite piezoelectric material, a piezoelectric vibrator, an ultrasonic probe, and an ultrasonic diagnostic apparatus, structured by using such a microstructure.

2. Description of a Related Art

Perovskite-type oxides, such as barium titanate (BaTiO₃) and lead zirconate titanate (PZT: PbZr_{X}Ti_{1-X}O₃), are widely used in a piezoelectric vibrator of an ultrasonic probe. In particular, ternary piezoelectric ceramic materials containing a perovskite-type complex compound, which is collectively referred to as a relaxor material, such as lead magnesium niobate (PMN: PbMg_{1/3}Nb_{2/3}O₃) or lead nickel niobate (PNN: PbNi_{1/3}Nb_{2/3}O₃), in the form of solid solution are widely used as the material for a piezoelectric vibrator due to its high piezoelectric constant.

The single crystal of a perovskite-type oxide containing such relaxer material and lead titanate is uniaxially polarized because it is a single crystal, and therefore, both its piezoelectric constant and electromechanical coupling coefficient are high. Thus, such a single crystal of a perovskite-type oxide attracts attention now as the material for a piezo electric vibrator. If such a perovskite-type oxide single crystal is used as a material for a piezoelectric vibrator in an ultrasonic probe to be used for medical applications or for nondestructive testing, significant improvement in the resolution and sensitivity can be achieved.

If the perovskite-type oxide single crystal as described above is used, matching with a transmission and reception circuit can be improved because it has a relative dielectric constant equivalent to or higher than that of the conventional relaxor-based piezoelectric ceramic. Furthermore, since the perovskite-type oxide single crystal has acoustic impedance that is smaller as compared with the acoustic impedance of a typical ceramic material and that is closer to the acoustic impedance of a human body, the acoustic impedance matching can be also achieved easily.

In the ultrasonic probe, an array type vibrator, in which a plurality of strip-shaped vibrators are arranged, is mostly used. Focusing, scanning, and so on of an ultrasonic beam are performed by the timing control of a voltage pulse applied to each of the vibrator elements. In the ultrasonic probe to be used for medical applications or for nondestructive testing, the operation frequency needs to be in a MHz range in order to achieve high resolution, and the size of one strip-shaped vibrator will be approximately 100 μm to 200 μm in width and approximately several hundred micrometers in height.

In such a strip-shaped vibrator, the electromechanical coupling coefficient of longitudinal vibration decreases by approximately ten percent as compared with the electromechanical coupling coefficient k33 of a rod-type piezoelectric element because the strip-shaped vibrator is restrained in horizontal expansion and contraction. In order to suppress a decrease in the electromechanical coupling coefficient in the strip-shaped vibrator, a composite structure, in which one vibrator is composed by combining rod-type piezoelectric elements with resin, i.e., the 1-3 composite, has been proposed. In the 1-3 composite, not only the electromechanical coupling coefficient is large as described above but also the acoustic impedance matching is achieved more easily because the acoustic impedance of the resin to be combined is small and the acoustic impedance as the vibrator is further reduced.

However, under the current circumstances, it is difficult to fabricate a micro-array of piezoelectric vibrators and furthermore, with regard to the individual vibrator, it is difficult to fabricate a piezoelectric oxide structure such as the 1-3 composite structure by machining. The piezoelectric oxide is very fragile, and will be immediately broken if a small crack occurs during machining. Even if the machining could be done, a damaged layer, a micro crack, or the like occurs in the machined surface because the machined surface received stress during machining, and thus, the inherent properties of a piezoelectric element cannot be obtained. There is then a need for a method of manufacturing a micro-column structure of perovskite-type oxide single crystal so as not to machine the single crystal, thereby not destroying the microstructure of single crystal.

Although a melt process is known as a method of manufacturing an oxide single crystal, it is difficult to fabricate the micro-column structure by using this method because some steps of this method are performed in the molten state. Moreover, as disclosed in Yamamoto et al., “Fabrication of Barium Titanate Single Crystals by Solid-State Grain Growth”, Journal of the American Ceramic Society, 1994, vol. 77, No. 4, pp. 1107-1109 and in Japanese Patent Application Publication JP-P2003-523919A (International Publication WO 01/63021 A1), a solid phase epitaxy method, in which single crystals are grown while keeping the material in a solid phase, is also known. This is a technique of joining a polycrystal oxide as a precursor of single crystals to a seed single crystal, and keeping them at a high temperature to induce solid phase epitaxy from an interface with the seed single crystal, thereby single-crystallizing the precursor. With the solid phase epitaxy method, single crystals can be obtained without melting. If the solid phase epitaxy method is used and the polycrystal oxide as the precursor is caused to have a micro-column structure in advance, then a single-crystallized micro-column structure may be able to be manufactured.

In the method as disclosed in Yamamoto et al. or in JP-P2003-523919A, the polycrystal oxide is joined to a seed single crystal and kept at a high temperature, whereby single crystallization starts from the interface with the seed single crystal. In microscopic view, a specific crystal grain, which has a crystal orientation aligned to the seed single crystal at the interface and is in contact with the seed single crystal, serves as a growth starting point, and as this grain grows, single crystallization proceeds. Accordingly, single crystallization will not necessarily proceed uniformly at the interface in the early stage of growth. Therefore, if polycrystal oxide as the precursor is caused to have a micro -column structure in advance, then the growth rate varies widely depending on the individual column, and in some of the columns, single crystallization may not occur from the seed crystal. As a result, some of the columns may have a coarsened polycrystal structure.

Moreover, Japanese Patent Application Publication JP-A-2-199094 discloses a method of manufacturing ferrite, in which a single crystal and a polycrystal having the same composition as that of the single crystal are joined together, and they are heated and held so as to single-crystallize the polycrystal. According to JP-A-2-199094, in order to uniformly grow crystals from the interface between the single crystal and the polycrystal, the precursor is uniaxially pressurized. However, if the precursor has a micro-column structure, the precursor will inevitably creep due to pressurization while it is held at high temperature, and therefore it is difficult to single-crystallize the polycrystal while maintaining the configuration of the micro-column structure.

### SUMMARY OF THE INVENTION

The present invention has been achieved in view of such problems. It is an object of the present invention to provide a microstructure of perovskite-type oxide single crystal having a desired composition and exhibiting excellent properties. It is another object of the present invention to provide a composite piezoelectric material, a piezoelectric vibrator, an ultrasonic probe, and an ultrasonic diagnostic apparatus, using such a microstructure of perovskite-type oxide single crystal.

In order to achieve the above-described objects, a method of manufacturing a microstructure of perovskite-type oxide single crystal according to one aspect of the present invention comprises the steps of: (a) forming a coating layer on a surface of a seed single crystal substrate, the coating layer containing the same metallic elements as those in a predetermined perovskite-type oxide; (b) forming a joint body having a micro-structured precursor of the predetermined perovskite-type oxide adhered to a surface of the coating layer; and (c) heat-treating the joint body to induce solid phase epitaxy, and thereby, single-crystallizing the precursor.

According to the one aspect of the present invention, the interface between the seed single crystal substrate and the precursor is covered with the coating layer containing the same metallic elements as those in the precursor. Therefore, when single-crystallizing the precursor by the heat treatment, solid phase epitaxy will continuously occur in the precursor under the influence of a large range of seed single crystal spreading around a narrow column of the micro-structured precursor. As a result, the column can be single-crystallized up to the tip thereof.

According to the above-described manufacturing method, no damage on the microstructure is observed because there is no need to machine the single crystal in order to form the microstructure. Moreover, the microstructure of perovskite-type oxide single crystal formed in this manner can serve as a high-performance composite piezoelectric material (1-3 composite) by being combined with a resin, and a piezoelectric vibrator and an ultrasonic probe can be constructed by using such a composite piezoelectric material. Furthermore, an ultrasonic diagnostic apparatus can be constructed by using such an ultrasonic probe.

### BRIEF DESCRIPTION OF THE DRAWINGS

FIG. 1 is a flow chart showing a method of manufacturing a microstructure of perovskite-type oxide single crystal and a product using the same, according to an embodiment of the present invention;

FIGS. 2A and 2B are conceptual cross sectional views illustrating single crystallization states of a precursor;

FIG. 3 is a flow chart illustrating a processing procedure in Example 1 of the present invention;

FIG. 4 is a flowchart illustrating a processing procedure in Example 6 of the present invention;

FIGS. 5A-5C are conceptual views showing configurations of a column structure which vary with steps in Example 6;

FIGS. 6A-6D are conceptual views illustrating changes in a workpiece during steps of fabricating a piezoelectric vibrator from a joint body in an embodiment of the present invention;

FIG. 7 shows a constructional example of a multilayered type piezoelectric vibrator according to an embodiment of the present invention;

FIG. 8 is a perspective view showing an internal structure of an ultrasonic probe according to an embodiment of the present invention; and

FIG. 9 is a block diagram showing a configuration of an ultrasonic diagnostic apparatus according to an embodiment of the present invention.

### DESCRIPTION OF THE PREFERRED EMBODIMENTS

Hereinafter, embodiments of the present invention will be described in detail with reference to the accompanying drawings.

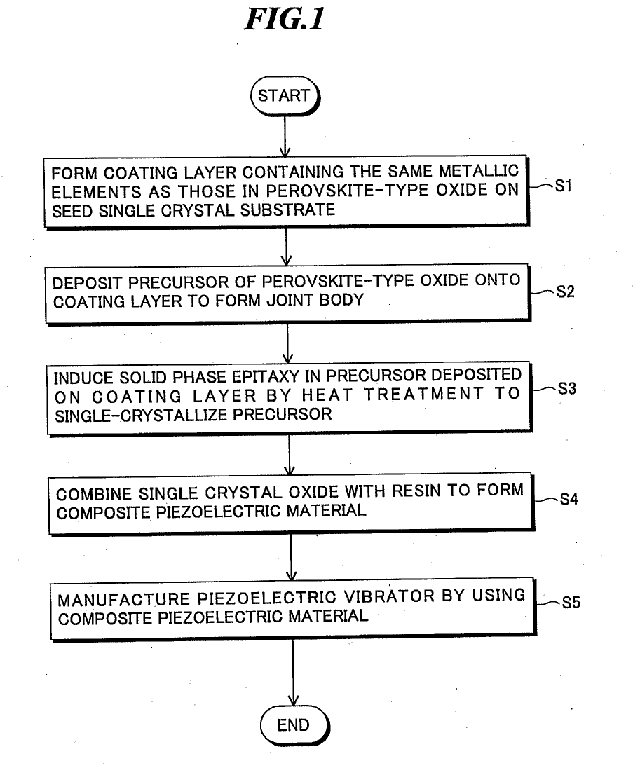

FIG. 1 is a flow chart showing a method of manufacturing a microstructure of perovskite-type oxide single crystal and a product using the same, according to an embodiment of the present invention. The method of manufacturing a microstructure of perovskite-type oxide single crystal according to the embodiment of the present invention includes the step of heat-treating a joint body of a micro-structured precursor of a perovskite-type oxide and a seed single crystal substrate to single-crystallize the precursor, and is characterized in that the whole interface surface of the seed single crystal substrate with the precursor is covered with a coating layer containing the same metallic elements as those in the precursor, whereby a column of the microstructure is reliably single-crystallized to the tip thereof.

At step S1 as shown in FIG. 1, a coating layer containing the same metallic elements as those in a predetermined perovskite-type oxide is formed on the surface of the seed single crystal substrate. For example, the coating layer is an amorphous film obtained by applying a solution formulated with an organic acid salt onto the substrate and pyrolyzing the solution. The organic acid salt may contain at least one metallic element effective in single crystallization in addition to metallic elements in a target perovskite-type oxide.

The perovskite-type oxide is an oxide having a perovskite-type crystal structure, in which a plurality of octahedrons formed of oxygen are arranged with their vertices shared with each other, and elements are located at a center of eight octahedrons and at a center of each octahedron. Here, assuming that an element located at the center of eight octahedrons is denoted by an A site element, and an element located at the center of each octahedron is denoted by a B site element, then the general formula of the perovskite-type crystal structure is represented by ABO₃. The coordination number of oxygen around the A site element is 12, and the coordination number of oxygen around the B site element is 6.

In the crystal structure of perovskite-type oxides, a composition with an excess of an element that is likely to exist at the A site contributes to crystallization to a greater degree. This is an element having a larger ion radius, and the examples of this are groups I to III elements in the periodic law, groups XI to XIII elements in the periodic law, lead (Pb), and bismuth (Bi). For this reason, the composition of the coating layer preferably contains at least one kind element of groups I to III elements in the periodic law, groups XI to XIII elements in the periodic law, lead (Pb), and bismuth (Bi) more than that in the composition of the micro-structured precursor.

The coating layer is preferably manufactured by using a chemical liquid-phase solution containing the metallic elements in the precursor (precursor oxide) because the pyrolysate of the chemical liquid-phase solution is firmly adhered to the seed single crystal, and therefore, single crystallization occurs more uniformly. In the chemical liquid-phase solution, inorganic acid salts or organic acid salts of various kinds of metallic elements, alkoxides, and a mixture of these can be used. As the solvent, an appropriate solvent having solubility relative to various kinds of salts can be used. As the chemical liquid-phase solution, a commercially available organic acid salt solution (for example, MOD material of KOJUNDO CHEMICAL LABORATORY CO., LTD.) can be used. The thickness of the coating layer is preferably within the range from 0.1 μm to 500 μm. If the coating layer is thinner than this, the effect of single crystallization cannot be observed, and if the coating layer is thicker than this, the crystal will not uniformly grow inside the micro-column under the influence of the crystal habit. Moreover, the coating layer may have a multilayered structure.

At step S2, the precursor of the target perovskite-type oxide is deposited and adhered onto the coating layer to form a joint body (intermediate complex). The joint body may be formed by the steps of converting perovskite single-phase powder as the precursor into a pressed powder compact by cold isostatic press (CIP), heating this pressed powder compact to form a sintered body, grinding the sintered body into a plate with a predetermined thickness, and performing thermocompression bonding of the plate to a surface of the coating layer. Alternatively, the joint body may be formed by the steps of leaving a seed single crystal substrate having a coated layer formed thereon, in a solution suspended with perovskite single-phase powder so as to deposit the powder, solidifying the deposited powder by CIP or the like, and sintering the resultant powder.

At step S3, the joint body is heat-treated at a high temperature to induce solid phase epitaxy in the precursor oxide deposited on the coating layer, thereby single-crystallizing the precursor oxide. At this time, if the precursor oxide is micro-structured in advance, the precursor oxide becomes a single crystal oxide having a microstructure. Micro-structuring of the precursor oxide is achieved by machining or laser beam machining the precursor layer of the joint body. The precursor layer is more easily workable because it is softer than the single crystal. Alternatively, the microstructure of single crystal oxide may be formed by the steps of applying a photosensitive resin film onto the coating layer, forming fine columnar through-holes in the photosensitive resin film by exposure using a mask and development, which serves as a mold, and filling perovskite single-phase powder into this mold to form a joint body having a microstructure of a precursor, and then, heat-treating the joint body.

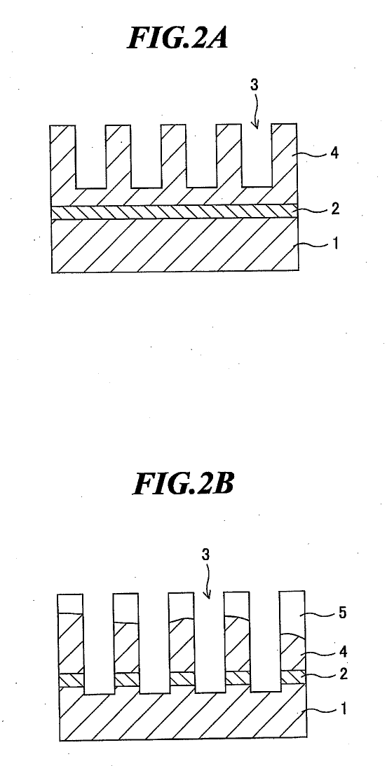

FIGS. 2A and 2B are conceptual cross sectional views illustrating single crystallization states of a precursor. FIG. 2A shows an example of a workpiece obtained by heat-treating the joint body. The workpiece is obtained by the steps of forming a coating layer 2 on a surface of a seed single crystal substrate 1, stacking a precursor of a perovskite-type oxide on the coating layer 2, and machining portions of the precursor by using a sizing machine to form a plurality of grooves 3 in orthogonal directions, thereby obtaining the micro-structured joint body, and then, heat-treating the joint body to single-crystallize the precursor. The precursor is single-crystallized to the tip thereof, and a single crystal oxide 4 is obtained.

FIG. 2B shows a comparative example of a workpiece obtained by heat-treating the joint body. In the workpiece as shown in FIG. 2B, the groove 3 is formed so as to reach not only the precursor, but also the coating layer 2, and furthermore the seed single crystal substrate 1. FIG. 23 indicates that the single crystal oxide 4 may be obtained at only the base portion of the precursor, and an amorphous phase 5 may remain at the tip portion of the precursor.

As shown in FIG. 2A, the single crystal oxide has a micro-column structure in which ceramic columns each having a large aspect ratio are arrayed, for example. A composite piezoelectric material (1-3 composite) can be obtained by impregnating a thermosetting resin, such as an epoxy resin, an urethane resin, or a phenol resin, between these columns or around these columns and then curing the thermosetting resin to combine the single crystal oxide with the resin (step S4 as shown in FIG. 1).

The composite piezoelectric material is ground to a predetermined thickness after curing the resin, and then electrodes are formed on both sides thereof to form a piezoelectric vibrator (step S5 as shown in FIG. 1). The electrodes can be formed by depositing metal, such as gold (Au), platinum (Pt), or nickel (Ni), on the surfaces of the composite piezoelectric material by using commonly-used metallic coating, such as electroless deposition, vacuum deposition, or sputtering. The electromechanical coupling coefficient in the piezoelectric vibrator can be improved by performing polarization processing after forming the electrodes. The polarlization processing is performed by applying an electric field of 1 kV/mm to 3 kV/mm to the composite piezoelectric material in an insulating oil.

Hereinafter, examples of the method of manufacturing the microstructure of perovskite-type oxide single crystal according to the present invention will be described.

### EXAMPLE 1

In Example 1, a single crystal of commercially available PMN (lead magnesium niobate)—PT (lead titanate) with 0.7 PMN—0.3 PT composition and along the (100) plane is used as the seed single crystal substrate, and perovskite single-phase powder with 0.7 PMN-0.3 PT composition and an average grain size of 1 μm is used as the oxide raw material to be single-crystallized, and furthermore, an organic acid salt solution of predetermined elements is used. Incidentally, in place of the organic acid salt solution, for example, a nitrate solution, an alkoxide solution, a mixture of these, or the like can be used as far as the predetermined elements have solubility at room temperature and is capable of forming a homogeneous solution.

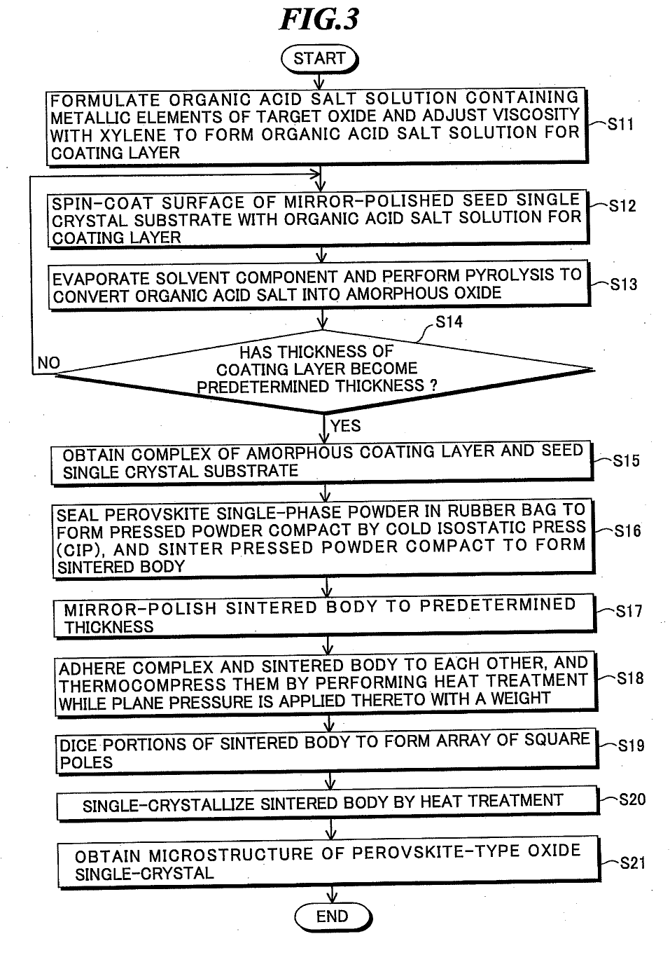

FIG. 3 is a flow chart illustrating a processing procedure in Example 1 of the present invention. An organic acid salt solution containing metallic elements of the target perovskite-type oxide, that is, lead (Pb), magnesium (Mg), niobium (Nb), and titanium (Ti) is formulated such that the mole ratio thereof becomes 30:7:14:9 (0.7 PMN-0.3 PT composition), and the viscosity of the solution is adjusted with xylene to form an organic acid salt solution for the coating layer (step S11).

On the other hand, the PMN-PT single crystal is mirror-polished to form the seed single crystal substrate, and the surface of the seed single crystal substrate is spin-coated with the organic acid salt solution for the coating layer (step S12). Next, the seed single crystal substrate is dried at 120° C. to evaporate the solvent component, and furthermore is pyrolyzed at 300° C. for 5 minutes to convert the organic acid salt into an amorphous oxide (step S13). By repeating the processes of steps S12 and S13 until the film thickness of the amorphous oxide as the coating layer becomes 0.5 μm (step S14), a complex of the amorphous coating layer and the seed single crystal substrate is obtained (step S15).

Next, the perovskite single-phase powder is sealed in a rubber bag, and is pressed to form a pressed powder compact by a cold isostatic press (CIP) of 200 MPa, and this pressed powder compact is sintered at 1200° C. for 3 hours to form a sintered body (step S16). The crystal grain size of the obtained sintered body is 3 μm on an average. The obtained sintered body is mirror-polished to a thickness of 0.5 mm (step S17). The complex of the amorphous coating layer and the seed single crystal substrate obtained at step S15 and the sintered body obtained at step S17 are adhered to each other, and are then thermocompressed by performing heat treatment for one hour at 700° C. while a plane pressure of 100 kPa is applied thereto with a weight (step S18). The amorphous in the coating layer is transformed into crystals, the grain size of which is 0.2 μm.

At step S18, dicing is performed on portions of the thermocompressed sintered body by using a blade with a thickness of 25 μm, whereby square poles each having a length of one side of 30 μm and a height of 200 μm are formed at a pitch of 60 μm (an interval between the square poles is 30 μm) (step S19). When a heat treatment for 5 hours at 1300° C. is performed, the square poles of the sintered body are single-crystallized to the surface portion thereof (step S20). In this manner, a microstructure of perovskite-type oxide single crystal can be obtained (step S21).

### EXAMPLE 2

In Example 2, the processing is performed under the same conditions and procedures as those in Example 1 except that the thermocompression temperature at step S18 of Example 1 is changed from 700° C. to 450° C. At the time of thermocompression, the coating layer is not crystallized but still remains in an amorphous state. However, thereafter, when dicing is performed and a heat treatment for 5 hours at 1300° C. is performed, the square poles formed in portions of the sintered body are single-crystallized to the surface portion thereof.

### EXAMPLE 3

In Example 3, the same processing as that in Example 2 is performed except that the organic acid salt solution for the coating layer is formulated such that the mole ratio thereof becomes K:Pb:Mg:Nb:Ti=3:30:7:14:9. The component ratio of the organic acid salt solution for the coating layer is obtained by adding potassium (K), which is a group I element in the periodic law, to the metal composition of the perovskite-type oxide applied to the sintered body. The coating layer still remains in an amorphous state even after thermocompression, and the square poles of the sintered body are single-crystallized to the surface portion thereof by the heat treatment. Since a metallic element effective in promoting crystallization is added, it is expected to speed up epitaxial growth and improve mass productivity.

### EXAMPLE 4

In Example 4, the same treatment as that in Example 2 is performed except that the organic acid salt solution for the coating layer is formulated such that the mole ratio thereof becomes La:Pb:Mg:Nb:Ti=3:30:7:14:9. The component ratio of the organic acid salt solution for the coating layer is obtained by adding lanthanum (La), which is a group III element in the periodic law, to the metal composition of the perovskite-type oxide applied to the sintered body. The coating layer still remains in an amorphous state even after thermocompression, and the square poles of the sintered body are single-crystallized to the surface portion thereof by the heat treatment. The mass productivity is expected to be improved.

### EXAMPLE 5

In Example 5, the same treatment as that in Example 2 is performed except that the organic acid salt solution for the coating layer is formulated such that the mole ratio thereof becomes Pb:Mg:Nb:Ti=35:7:14:9. The component ratio of the organic acid salt solution for the coating layer is obtained by increasing a ratio of lead (Pb) in comparison with the metal composition of the perovskite-type oxide applied to the sintered body. The coating layer still remains amorphous even after thermocompression, and the square poles of the sintered body are single-crystallized to the surface portion thereof by the heat treatment. The mass productivity is expected to be improved.

### EXAMPLE 6

In Example 6, the same treatment as that in Example 1 is performed except that a mold is formed on the coating layer and single-phase powder is precipitated and deposited in the mold, instead of joining the single-phase sintered body onto the coating layer on the seed single crystal substrate.

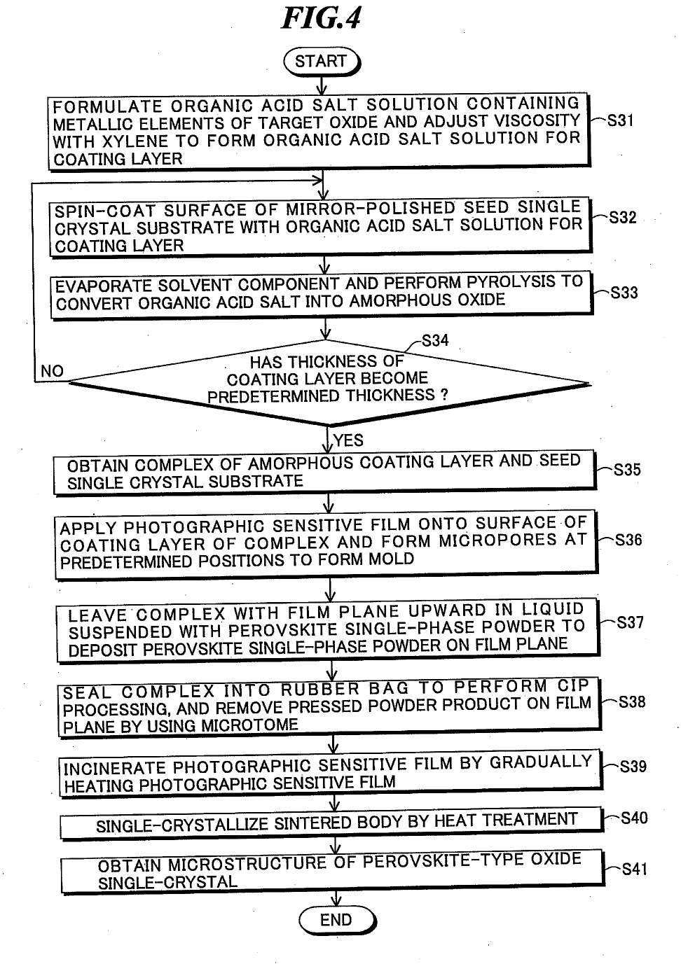

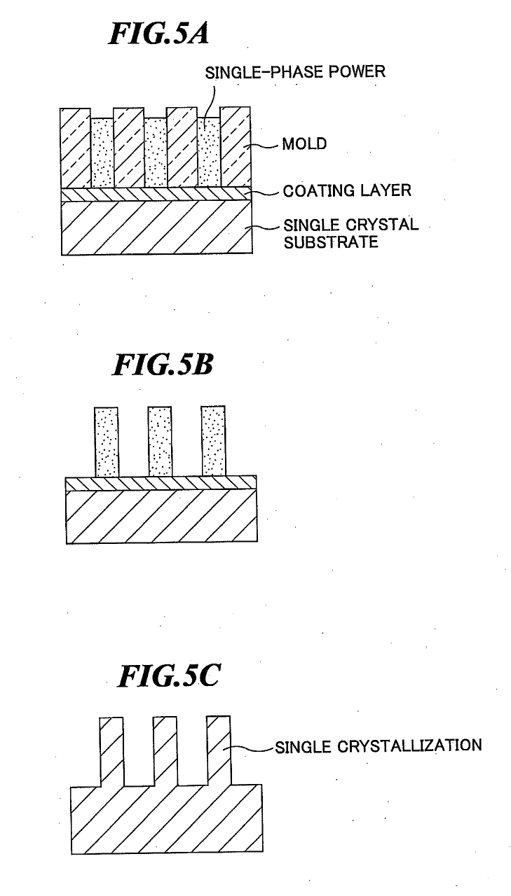

FIG. 4 is a flow chart illustrating a processing procedure in Example 6 of the present invention, and FIGS. 5A-5C are conceptual views showing configurations of a column structure which vary with the steps in Example 6.

Similarly to steps S11 to S15 in Example 1, a complex of a seed single crystal substrate with an amorphous coating layer applied thereon is obtained (steps S31 to S35 in FIG. 4). A photographic sensitive film with a thickness of 250 μm is applied onto the surface of the coating layer of the complex, and then, micropores with a diameter of 40 μm are formed in the film at an interval of 60 μm by exposure using a mask and development, which serves as a mold (step S36). As the photographic sensitive film, for example, a commercially available film-like resin such as SU-8 3000 DFR (KAYAKU MICROCHEM CO., LTD.) can be used. In a liquid suspended with perovskite single-phase powder, the complex provided with the mold is left with the photographic sensitive film plane upward so as to precipitate the perovskite single-phase powder and deposit the perovskite single-phase powder on the film plane (step S37).

In order to fill powder particles into the micropores, the dispersibility of the fine particles as a raw material powder needs to be improved in advance. There is a problem that the fine particles (primary particles) are likely to agglomerate due to the Van der Waals force or the crosslinking effect of moisture. Since the agglomerated particle (secondary particle) has a large diameter as compared with the primary particle, the agglomerated particle is hard to be filled into the micropore, resulting in a decrease in the filling density. Therefore, the perovskite single-phase powder is preferably dispersed in the liquid with the surface thereof coated with a surface active agent. By using the surface active agent which acts on the fine particles, the dispersibility between the fine particles will improve, and as a result, when filling the fine particles into the mold, the fine particles will fill even the corners of the mold.

The resultant joint body (intermediate complex) is sealed into a rubber bag in order to increase denseness of the deposit, and after CIP processing at 200 MPa, the pressed powder product on the film plane is removed by using a microtome (step S38). As shown in FIG. 5A, the perovskite single-phase powder is filled into the micropores in the mold formed of the photographic sensitive film on the coating layer provided on the seed single crystal substrate. By gradually heating the photographic sensitive film up to 450° C., the photographic sensitive film is incinerated to obtain a configuration as shown in FIG. 5B. And then, a heat treatment for 5 hours at 1300° C. is performed thereon to single-crystallize the sintered body (step S40). As a result, a microstructure of perovskite-type oxide single crystal including an array of fine cylinders each having a diameter of 35 μm and a height of approximately 200 μm as shown in FIG. 5C is obtained (step S41)

### COMPARATIVE EXAMPLE 1

Through the manufacture by the same procedure as that in Example 1, a complex having the coating layer provided on the seed single crystal substrate and the perovskite sintered body are bonded to each other by thermocompression, and thereafter, a thickness of the sintered body is set to be 180 μm by polishing. Thereafter, dicing is performed on the surface of the sintered body by using a blade with a thickness of 25 μm, whereby square poles each having a length of one side of 30 μm and a height of 200 μm are formed at a pitch of 60 μm (an interval between the square poles is 30 μm). At this time, since notches are cut down to the single crystal substrate portion, approximately ten percent of the micro-columns are damaged. Furthermore, when a heat treatment for 5 hours at 1300° C. is performed, some of the square poles are single-crystallized to the surface portion thereof but this ratio is approximately 50%.

### COMPARATIVE EXAMPLE 2

The same processing as that in Example 6 is performed except that PMN-PT single crystal without an amorphous coating is used. Approximately 70% of microcylinders each having a diameter of 35 μm and a height of approximately 200 μm are single-crystallized to the surface thereof, while for the remaining 30%, the entire column is a polycrystal, or the upper part thereof is a polycrystal although the microcylinder is single-crystallized from the interface to the halfway to the tip.

Next, in the method of manufacturing a microstructure of perovskite-type oxide single crystal and a product using the same according to an embodiment of the present invention as shown in FIG. 1, the steps of fabricating a piezoelectric vibrator from the joint body will be described in detail.

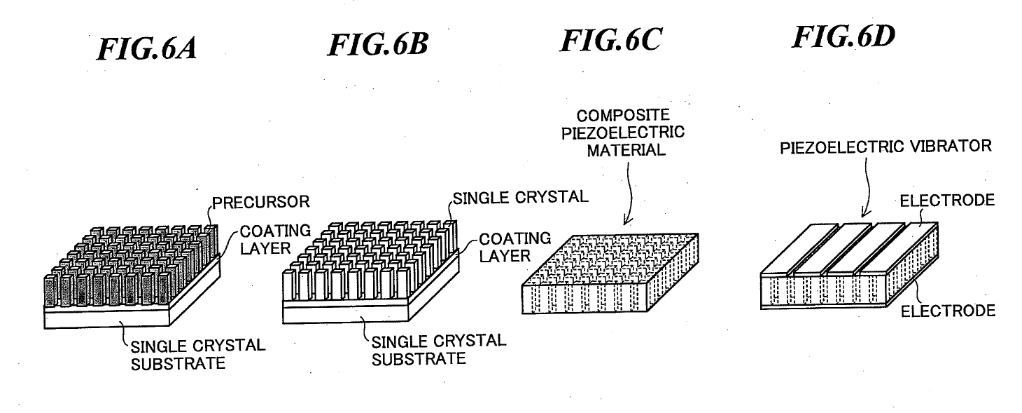

FIGS. 6A-6D are conceptual views illustrating changes in a workpiece during the steps of fabricating the piezoelectric vibrator from the joint body having a precursor of perovskite-type oxide disposed on a seed single crystal substrate via a coating layer for promoting single crystallization.

The joint body as shown in FIG. 6A forms a microstructure in which a plurality of mutually orthogonal grooves are formed in the precursor portion. The solid phase epitaxy is induced in the precursor by the heat treatment of the joint body, and the precursor is single-crystallized. As a result, a single crystal oxide having a micro-column structure as shown in FIG. 6B is obtained. When thermosetting resin is impregnated between the columns of the obtained single crystal oxide and cured, and ground to a predetermined thickness according to need, and thereby, a composite piezoelectric material (1-3 composite) having micro single crystal columns embedded in the resin as shown in FIG. 6C is obtained. This composite piezoelectric material can serve as a piezoelectric vibrator as shown in FIG. 6D by forming electrodes on the both sides and polarizing the composite piezoelectric material. Furthermore, a multilayered type piezoelectric vibrator can be constructed by stacking the composite piezoelectric materials and the electrodes.

Next, a multilayered type piezoelectric vibrator according to an embodiment of the present invention will be described.

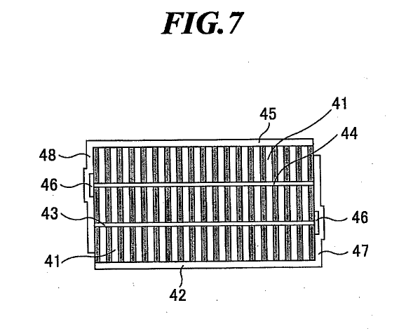

FIG. 7 shows a constructional example of a multilayered type piezoelectric vibrator according to an embodiment of the present invention. In this embodiment, the multilayered type piezoelectric vibrator is constructed by alternatively stacking a plurality of composite piezoelectric materials (1-3 composites) and a plurality of electrodes. As shown in FIG. 7, the multilayered type piezoelectric vibrator comprises a plurality of composite piezoelectric material layers 41, a lower electrode layer 42, internal electrode layers 43 and 44 alternatively inserted between the plurality of composite piezoelectric material layers 41, an upper electrode layer 45, an insulating film 46, and side surface electrodes 47 and 48. The multilayered type piezoelectric vibrator has such a multilayered structure.

The lower electrode layer 42 is connected to the side surface electrode 47 but isolated from the side surface electrode 48. The upper electrode layer 45 is connected to the side surface electrode 48 but isolated from the side surface electrode 47. Moreover, the internal electrode layer 43 is connected to the side surface electrode 48, but isolated from the side surface electrode 47 by the insulating film 46. On the other hand, the internal electrode layer 44 is connected to the side surface electrode 47, but isolated from the side surface electrode 48 by the insulating film 46. By forming a plurality of electrodes of the ultrasonic transducer in this manner, three sets of electrodes for applying an electric field to a three-layered composite piezoelectric material layer 41 are connected in parallel. Incidentally, the number of layers of the composite piezoelectric material layer is not limited to three layers, but may be two layers, or four layers or more.

In such a multilayered type piezoelectric vibrator, the electrical impedance will decrease because the area of opposing electrodes increases more than that of a single-layer type piezoelectric vibrator. Therefore, as compared with a single-layer type piezoelectric vibrator with the same size, such a multilayered type piezoelectric vibrator operates efficiently with respect to the applied voltage. Specifically, if the number of piezoelectric element layers is set to be N, the number of piezoelectric element layers becomes N times that of a single-layered type piezoelectric vibrator and the thickness of each of the piezoelectric element layers becomes 1/N time that of the single-layered type piezoelectric vibrator. Accordingly, the electrical impedance of the piezoelectric vibrator becomes 1/N². Therefore, the electrical impedance of a piezoelectric vibrator can be adjusted by increasing or decreasing the number of stacked layers of the piezoelectric element layer. As a result, electrical impedance matching with a driving circuit or a signal cable can be easily achieved, and the sensitivity can be improved.

Next, an ultrasonic probe according to an embodiment of the present invention will be described.

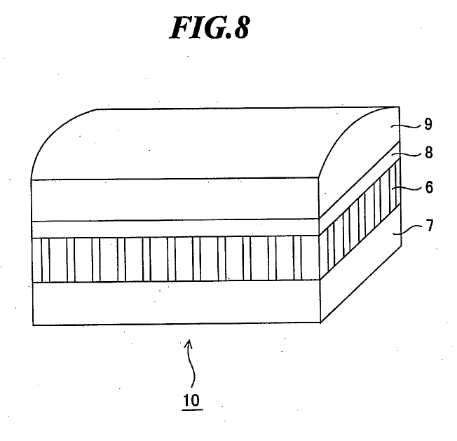

FIG. 8 is a perspective view showing an internal structure of the ultrasonic probe according to an embodiment of the present invention. The ultrasonic probe 10 can be fabricated by combining a vibrator array 6 employing the polarized composite piezoelectric material (1-3 composite), a backing material 7 disposed on a first surface of the vibrator array 6, at least one acoustic matching layer 8 disposed on a second surface opposite to the first surface of the vibrator array 6, and an acoustic lens 9, and furthermore, by connecting wirings to the vibrator array 6 by using a well-known method. Further, in the ultrasonic probe 10, a multilayered type piezoelectric vibrator constructed by stacking a plurality of composite piezoelectric materials and a plurality of electrodes can be used.

Next, an ultrasonic diagnostic apparatus according to an embodiment of the present invention will be described.

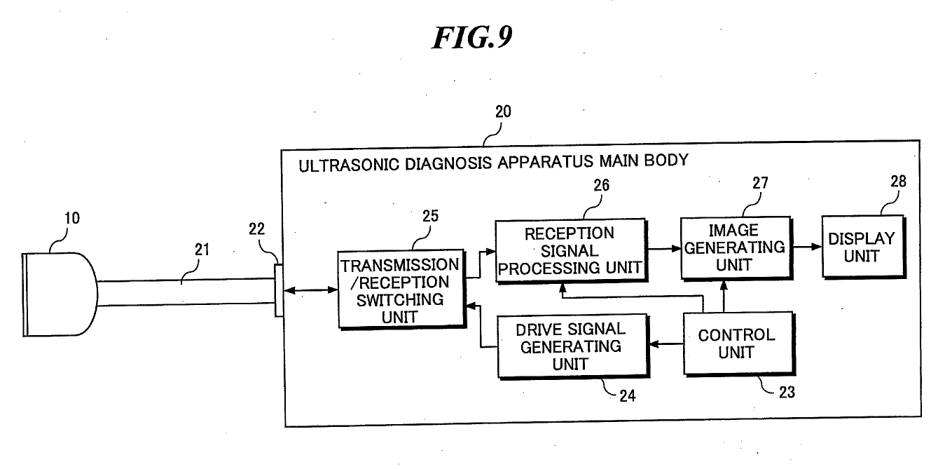

FIG. 9 is a block diagram showing a configuration of the ultrasonic diagnostic apparatus according to an embodiment of the present invention. This ultrasonic diagnostic apparatus comprises an ultrasonic probe according to an embodiment of the present invention and an ultrasonic diagnostic apparatus main body.

As shown in FIG. 9, an ultrasonic probe 10 includes a plurality of ultrasonic transducers constituting a one-dimensional or two-dimensional transducer array (vibrator array), and is electrically connected to an ultrasonic diagnostic apparatus main body 20 via an electrical cable 21 and a connector 22. The electrical cable 21 transmits drive signals generated in the ultrasonic diagnostic apparatus main body 20 to the respective ultrasonic transducers (piezoelectric vibrators), and transmits reception signals outputted from the respective ultrasonic transducers to the ultrasonic diagnostic apparatus main body 20.

The ultrasonic diagnostic apparatus main body 20 includes a control unit 23 for controlling the operation of the whole ultrasonic diagnostic apparatus, a drive signal generating unit 24, a transmission/reception switching unit 25, a reception signal processing unit 26, an image generating unit 27, and a display unit 28. The drive signal generating unit 24 includes, for example, a plurality of driving circuits (pulsers or the like), and generates drive signals to be used for driving a plurality of ultrasonic transducers, respectively, and supplies these drive signals to the vibrator array. The transmission/reception switching unit 25 switches between the output of drive signals to the ultrasonic probe 10 and the input of reception signals from the ultrasonic probe 10.

The reception signal processing unit 26 includes, for example, a plurality of preamplifiers, a plurality of A/D converters, a digital signal processing circuit or a CPU, and performs predetermined signal processing, such as amplification, phase matching and addition, envelope detection, etc. on the reception signals outputted from the plurality of ultrasonic transducers. The image generating unit 27 generates an image signal representing an ultrasonic image based on reception signals in which a predetermined signal processing has been undergone. The display unit 28 displays an ultrasonic image based on the image signal thus generated. Here, the reception signal processing unit 26 and the image generating unit 27 constitute a signal processing means which generates an image signal representing an ultrasonic image by processing reception signals outputted from the vibrator array.

1. A method of manufacturing a microstructure of perovskite-type oxide single crystal, said method comprising the steps of:
(a) forming a coating layer on a surface of a seed single crystal substrate, said coating layer containing the same metallic elements as those in a predetermined perovskite-type oxide;
(b) forming a joint body having a micro-structured precursor of said predetermined perovskite-type oxide adhered to a surface of said coating layer; and
(c) heat-treating said joint body to induce solid phase epitaxy, and thereby, single-crystallizing said precursor.

2. The method according to claim 1, wherein said coating layer has a thickness within a range from 0.1 μm to 500 μm.

3. The method according to claim 1, wherein said coating layer has a crystal grain size smaller than that of said precursor.

4. The method according to claim 1, wherein said coating layer includes an amorphous portion.

5. The method according to claim 1, wherein said coating layer has a composition, in which at least one kind element of groups I to III elements in the periodic law, groups XI to XIII elements in the periodic law, lead (Pb), and bismuth (Bi) is contained more than that in a composition of the precursor.

6. The method according to claim 1, wherein said coating layer is manufactured by chemical liquid-phase method.

7. The method according to claim 1, further comprising the step of:
forming a microstructure in said precursor by one of machining and laser beam machining, between step (a) and step (b).

8. The method according to claim 1, wherein said precursor has a microstructure formed by filling powder of said predetermined perovskite-type oxide into a mold formed with columnar through-holes.

9. The method according to claim 1, wherein said seed single crystal substrate has a perovskite-type crystal structure having a grating constant which differs from that of said precursor by no longer than 5% at room temperature.

10. A microstructure of perovskite-type oxide single crystal manufactured by the manufacturing method according to claim 1.

11. The microstructure of perovskite-type oxide single crystal according to claim 10, wherein said perovskite-type oxide contains lead (Pb).

12. A composite piezoelectric material manufactured by combining a microstructure of perovskite-type oxide single crystal manufactured by the method according to claim 1 with a resin.

13. A piezoelectric vibrator comprising:
a composite piezoelectric material manufactured by combining a microstructure of perovskite-type oxide single crystal manufactured by the method according to claim 1 with a resin; and
a plurality of electrodes provided at both ends of said composite piezoelectric material.

14. A piezoelectric vibrator comprising:
a first electrode layer and a second electrode layer; and
a plurality of composite piezoelectric material layers alternatively stacked with at least one internal electrode layer between said first electrode layer and said second electrode layer, each of said plurality of composite piezoelectric material layers being manufactured by combining a microstructure of perovskite-type oxide single crystal manufactured by the method according to claim 1 with a resin.

15. An ultrasonic probe comprising:
a vibrator array employing a composite piezoelectric material manufactured by combining a microstructure of perovskite-type oxide single crystal manufactured by the method according to claim 1 with a resin;
a backing material disposed on a first surface of said vibrator array; and
at least one acoustic matching layer disposed on a second surface opposite to the first surface of said vibrator array.

16. An ultrasonic diagnostic apparatus comprising:
an ultrasonic probe including a vibrator array employing a composite piezoelectric material manufactured by combining a microstructure of perovskite-type oxide single crystal manufactured by the method according to claim 1 with a resin;
drive signal supply means for supplying drive signals to said vibrator array; and
signal processing means for processing reception signals outputted from said vibrator array to generate an image signal representing an ultrasonic image.
